(19) United States
(12) Patent Application Publication
(10) Pub. No.: US 2016/0366748 A1
(43) Pub. Date: Dec. 15, 2016

(54) DETECTING CIRCUIT AND ELECTRONIC DEVICE USING THE SAME

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: YANG GAO, Shenzhen (CN); MENG-LIANG YANG, Shenzhen (CN)

(21) Appl. No.: 14/788,989

(22) Filed: Jul. 1, 2015

(30) Foreign Application Priority Data
Jun. 12, 2015 (CN) 201510322883.2

(51) Int. Cl. H05B 37/02; H05B 33/08

(52) U.S. Cl. CPC H05B 37/029; H05B 33/0845

(57) ABSTRACT

The disclosure provides a detecting circuit including a controller and a light emitting diode (LED). The controller obtains a plurality of sequence signals output by a plurality of sequence signal terminals of the motherboard. The LED is electrically coupled to the controller. When the controller obtains a sequence signal from one of the sequence signal terminals of the motherboard, the controller outputs a first control signal to the LED, and the LED flashes once. An electronic device including the detecting circuit is also provided.

### FIELD

The subject matter herein generally relates to electronic devices and particularly to an electronic device with a detecting circuit.

### BACKGROUND

Generally, when a motherboard is undergoing a power-on self test (POST), a lot of light emitting diodes (LEDs) are needed to display operation of the motherboard. However, the LEDs occupy space the motherboard.

### BRIEF DESCRIPTION OF THE DRAWINGS

Implementations of the present technology will now be described, by way of example only, with reference to the attached figures.

FIG. 1 is block diagram of an embodiment of an electronic device of the present disclosure, the electronic device comprising a detecting circuit.

FIG. 2 is a circuit diagram of an example embodiment of the detecting circuit of FIG. 1, wherein the detecting circuit is electrically coupled to a motherboard.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

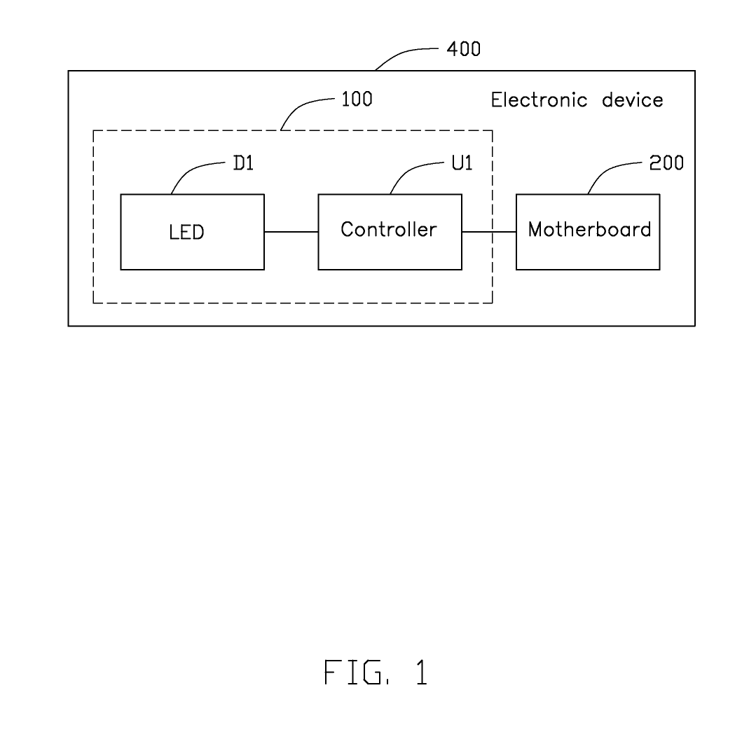

FIG. 1 illustrates an electronic device 400 of the present disclosure. The electronic device 400 in accordance with an exemplary embodiment can comprise a detecting circuit 100 and a motherboard 200. The motherboard 200 is configured to perform a power-on self-test (POST) diagnostic program for the components in the computer system when the motherboard 200 is booted. The detecting circuit 100 is configured for detecting the boot running states of the motherboard 200. The detecting circuit 10 can comprise a controller U1 and a light emitting diode (LED) D1. Both the motherboard 200 and the LED D1 are electrically coupled to the controller U1. The controller U1 obtains a plurality of sequence signals from the motherboard 200, and outputs a control signal to the LED D1 according to the sequence signals output by the motherboard 200. The LED D1 flashes according to the control signal output by the controller U1.

In at least one embodiment, the controller U1 is a complex programmable logic device (CPLD).

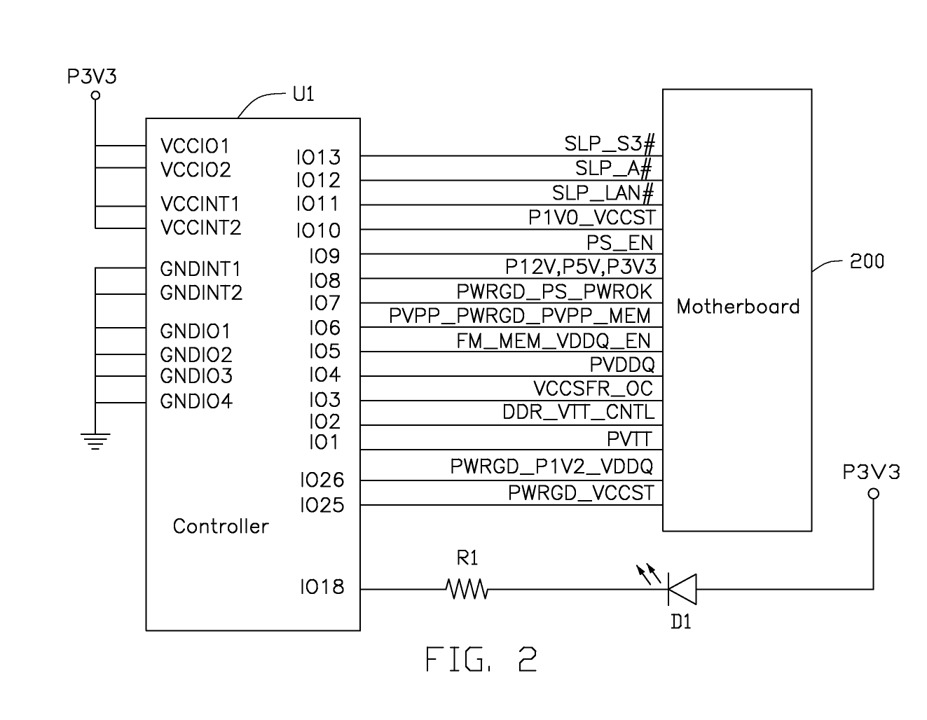

FIG. 2 illustrates an embodiment of the detecting circuit 100. Four power supply pins VCCIO1, VCCIO2, VCCINT and VCCINT2 of the controller U1 are electrically coupled to a power supply P3V3. Six ground pins GNDINT1, GNDINT2 and GNDIO1-GNDIO4 of the controller U1 are electrically coupled to a ground. Thirteen signal input pins IO1-IO13 of the controller U1 are electrically coupled to thirteen sequence signal terminals PVTT, DDR_VTT_CNTL, VCCSFR_OC, PVDDQ, FM_MEM_VDDQ_EN, PVPP_PWRGD_PVPP_MEM, PWRGD_PS_PWROK, P12V,P5V,P3V3V, PS_EN, P1V0_VCCST, SLP_LAN#, SLP_A#, and SLP_S3# of the motherboard 200, respectively. Two signal input pins 1025 and 1026 of the controller U1 are electrically coupled to two sequence signal terminals PWRGD_VCCST and PWRGD_P1V2_VDDQ of the motherboard 200, respectively.

A cathode of the LED D1 is electrically coupled to a signal output pin 1018 of the controller U1 through a resistor R1. An anode of the LED D1 is electrically coupled to the power supply P3V3.

The POST is performed to check all the components of the motherboard 200 sequentially. When each of the components of the motherboard 200 is checked, and a corresponding sequence signal terminal of the motherboard 200 outputs a sequence signal to a corresponding signal input pin of the controller U1.

In use, the motherboard 200 is booted, and the POST diagnostic program is executed. When the components of the motherboard 200 are in good working order, thirteen signal input pins IO1-IO13 of the controller U1 receive sequence signals in order output by the sequence signal terminals PVTT, DDR_VTT_CNTL, VCCSFR_OC, PVDDQ, FM_MEM_VDDQ_EN, PVPP_PWRGD_PVPP_MEM, PWRGD_PS_PWROK, P12V,P5V,P3V3V, PS_EN, P1V0_VCCST, SLP_LAN#, SLP_A#, and SLP_S3# of the motherboard 200. Once receiving a sequence signal, the controller U1 outputs a first control signal to the LED D1, the LED D1 flashes once.

When an error of the motherboard 200 in the boot process is checked, the POST is ended, a corresponding sequence signal terminal of the motherboard 200 does not output a corresponding sequence signal to the controller U1, and the remaining sequence signal terminals of the motherboard 200 do not output corresponding sequence signals the controller U1. The controller U1 outputs a second control signal at a high-voltage level to the LED D1, and the LED D1 is turned off. Thus, users can count the flash times of the LED D1 to find the error. For example, if the CPU fan has any error, the LED D1 flashes twice.

The embodiments shown and described above are only examples. Many details are often found in the art such as the other features of the electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A detecting circuit comprising:
a controller is configured for obtaining a plurality of sequence signals from a motherboard;
a light emitting diode (LED) electrically coupled to the controller;
wherein when the controller obtains a sequence signal from the motherboard, the controller outputs a first control signal to the LED, and the LED flashes.

2. The detecting circuit of claim 1, wherein the controller comprises a plurality of signal input pins, each signal input pin is electrically coupled to a corresponding sequence signal terminal of the motherboard to obtain a corresponding sequence signal from the motherboard.

3. The detecting circuit of claim 2, wherein the controller further comprises a signal output pin, the signal output pin is electrically coupled to a cathode of the LED through a resistor, an anode of the LED is electrically coupled to a power supply.

4. The detecting circuit of claim 3, wherein when the controller does not obtains a sequence signal from the motherboard, the controller outputs a second control signal to the LED, and the LED is turned off.

5. The detecting circuit of claim 4, wherein the controller is a complex programmable logic device (CPLD).

6. An electronic device comprising:
a motherboard; and
a detecting circuit comprising:
a controller is configured for obtaining a plurality of sequence signals from a motherboard;
a light emitting diode (LED) electrically coupled to the controller;
wherein when the controller obtains a sequence signal from the motherboard, the controller outputs a first control signal to the LED, and the LED flashes.

7. The electronic device of claim 6, wherein the controller comprises a plurality of signal input pins, each signal input pin is electrically coupled to a corresponding sequence signal terminal of the motherboard to obtain a corresponding sequence signal from the motherboard.

8. The electronic device of claim 7, wherein the controller further comprises a signal output pin, the signal output pin is electrically coupled to a cathode of the LED through a resistor, an anode of the LED is electrically coupled to a power supply.

9. The electronic device of claim 8, wherein when the controller does not obtains a sequence signal from the motherboard, the controller outputs a second control signal to the LED, and the LED is turned off.

10. The electronic device of claim 9, wherein the controller is a complex programmable logic device (CPLD).
